(19) United States
(12) Patent Application Publication
(10) Pub. No.: US 2026/0239117 A1
(43) Pub. Date: Aug. 13, 2026

(54) HANDLING OF COLLECTED DATA DURING MOBILITY

(71) Applicant: InterDigital Patent Holdings, Inc., Wilmington, DE (US)

(72) Inventors: Oumer Teyeb, Montreal (CA); Faris Alfarhan, Montreal (CA); Diana Pani, Montreal (CA); Yugeswar Deenoo Narayanan Thangaraj, Chalfont, PA (US); Dylan Watts, Montreal (CA); Michael Starsinic, Newtown, PA (US); Ulises Olvera-Hernandez, Saint-Lazare (CA)

(73) Assignee: InterDigital Patent Holdings, Inc., Wilmington, DE (US)

(21) Appl. No.: 19/048,136

(22) Filed: Feb. 7, 2025

(51) Int. Cl. H04W 36/00

(52) U.S. Cl. CPC H04W 36/0061; H04W 36/0085

(57) ABSTRACT

A wireless transmit/receive unit (WTRU) may receive configuration information. The configuration information may include one or more first conditions, for example associated with collected data. The WTRU may determine to perform handover (HO), for example from a first cell to a second cell. The WTRU may determine whether the one or more first conditions associated with the collected data are satisfied, for example in response to the determination to perform HO from the first cell to the second cell. The WTRU may perform HO to the second cell. In response to the performance of HO to the second cell and/or based on the determination of whether the one or more first conditions associated with collected data are satisfied for example, The WTRU perform one or more of maintaining the collected data, discarding the collected data, and/or maintaining the collected data for a predetermined time.

### BACKGROUND

Artificial intelligence/machine learning (AI/ML) may be integrated into a network, for example a fifth generation (5G) new radio (NR) network. AI/ML may enhance air-interface performance (e.g., improved throughput, robustness, accuracy or reliability, etc.) and/or reduce complexity/overhead. AI/ML may impact beam management, positioning, and CSI prediction.

Artificial intelligence (AI) may include behavior exhibited by machines that, for example may mimic cognitive functions to sense, reason, adapt, and/or act. Machine learning (ML) may include algorithms (e.g., types of algorithms) that solve a problem based on learning through experience (e.g., data), for example without being explicitly programmed (e.g., configuring a set of rules). ML may be a subset of AI. Different ML paradigms may be envisioned, for example based on the nature of data or feedback available to the learning algorithm. A supervised learning approach may involve learning a function that maps input to an output based on labeled training example. A (e.g., each) training example may include a pair. The pair may include an input and a corresponding output. An unsupervised learning approach may involve detecting patterns in the data with no pre-existing labels. A reinforcement learning approach may involve performing a sequence of actions in an environment, for example to maximize the cumulative reward. ML algorithms may be applied using a combination and/or interpolation of the approaches herein. For example, a semi-supervised learning approach may use a combination of a small amount of labeled data with a large amount of unlabeled data during training. Semi-supervised learning may fall between unsupervised learning (e.g., with no labeled training data) and supervised learning (e.g., with only labeled training data).

### SUMMARY

A wireless transmit/receive unit (WTRU) may be configured to conditionally discard/maintain collected data, for example during mobility. Additionally, or alternatively, the WTRU may be configured to discard/maintain collected data based on a determination of whether a source cell and a target cell belong to the same data collection relevance/domain. The WTRU may be configured to conditionally discard/maintain collected data during mobility, for example based on the characteristics of the collected data. The WTRU may be configured to maintain collected data after mobility, for example for a certain configured time duration. The WTRU may be configured to discard the data, for example when the time duration has elapsed. Additionally, or alternatively, the WTRU may be configured to maintain and/or discard the data if the WTRU has not been handed over back to the source cell and/or a cell that has a similar data collection relevance/domain as the source cell.

The WTRU may receive configuration information. The configuration information may include one or more first conditions, for example associated with collected data. The WTRU may determine to perform handover (HO), for example from a first cell to a second cell. The WTRU may determine whether the one or more first conditions associated with the collected data are satisfied, for example in response to the determination to perform HO from the first cell to the second cell. The WTRU may perform HO to the second cell. In response to the performance of HO to the second cell and/or based on the determination of whether the one or more first conditions associated with collected data are satisfied for example, The WTRU perform one or more of maintaining the collected data, discarding the collected data, and/or maintaining the collected data for a predetermined time.

The one or more first conditions may include one or more of a condition for maintaining the collected data, a condition for discarding the collected data, and/or a condition for maintaining the collected data for the predetermined time. The WTRU may maintain the collected data based on a determination that the condition for maintaining collected data is satisfied. The WTRU may discard the collected data based on a determination that the condition for discarding the collected data is satisfied. The WTRU may maintain the collected data for the predetermined time based on a determination that the condition for maintaining the collected data for the predetermined time is satisfied.

The WTRU may send a HO complete message, for example to a network. The HO complete message may include an indication of one or more of the collected data being maintained, the collected data being discarded, and/or the collected data being maintained for the predetermined time. The WTRU may receive a HO command from a network and/or determine to perform the HO to the second cell based on the HO command from the network. The WTRU may determine to perform the HO to the second cell, for example based on one or more conditional handover (CHO) conditions being satisfied.

The one or more first conditions may include an indication of whether the first cell and the second cell are in a same data relevancy domain. The WTRU may maintain the collected data, discard the collected data, and/or maintain the collected data for a predetermined time, for example based on a determination of whether the first cell and second cell are in the same data relevancy domain. The WTRU may maintain the collected data based on a determination that the first cell and the second cell are in the same data relevancy domain. The WTRU may discard the collected data based on a determination that the first cell and the second cell are not in the same data relevancy domain. The WTRU may maintain the collected data for the predetermined time based on a determination that the first cell and the second cell are not in the same data relevancy domain. The WTRU may maintain the collected data for a predetermined time and/or discard the collected data, for example based on a determination that the predetermined time has elapsed after the performance of the HO to the second cell and/or based on a determination that the WTRU has not performed a second HO to one or more of the first cell or to a third cell. The third cell may be in a same data relevancy domain as the first cell.

The one or more first conditions may include a mobility type. The WTRU may determine whether the one or more first conditions associated with the collected data are satisfied based on the mobility type. The one or more first conditions may include a volume of the collected data. The WTRU may discard the collected data when the volume of collected data exceeds a volume threshold. The WTRU may send a message to a network. The message may include a request to discard the collected data. The WTRU may receive a message from the network. The message may include an indication to discard the collected data. The WTRU may discard the collected data based on the message/indication to discard the collected data.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

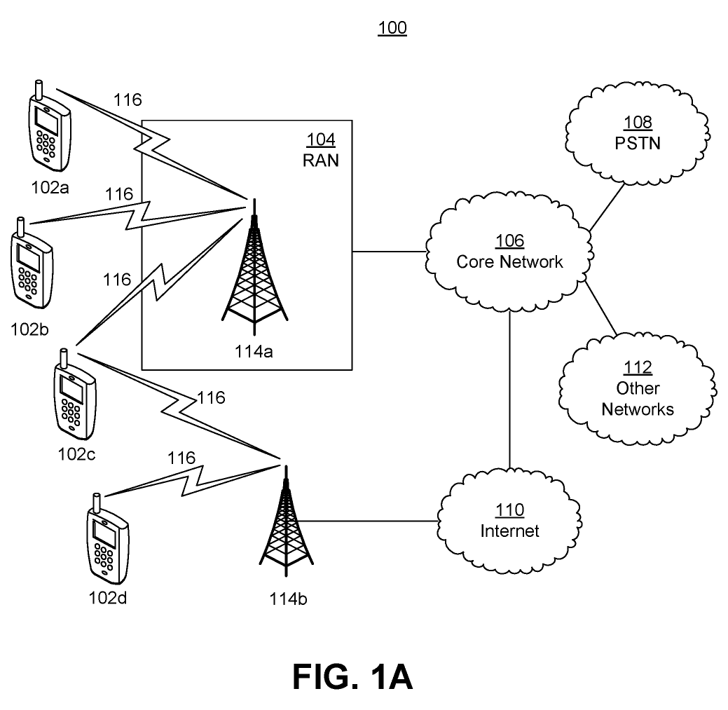

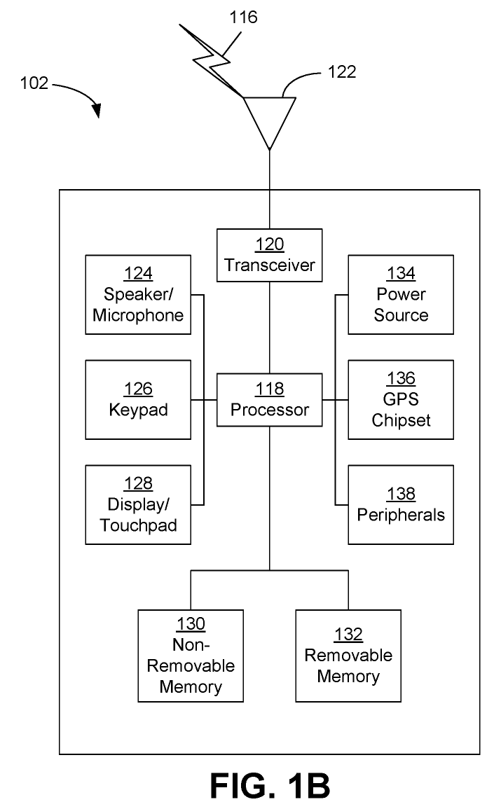

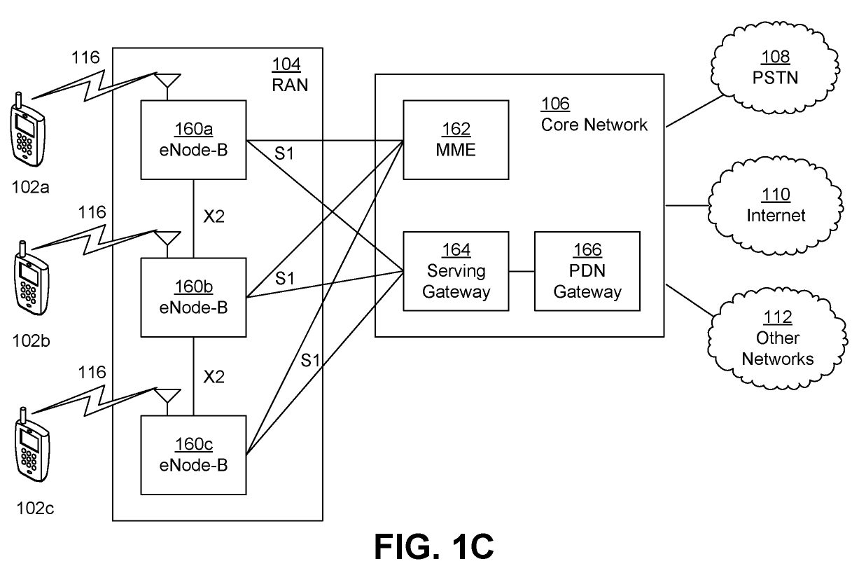

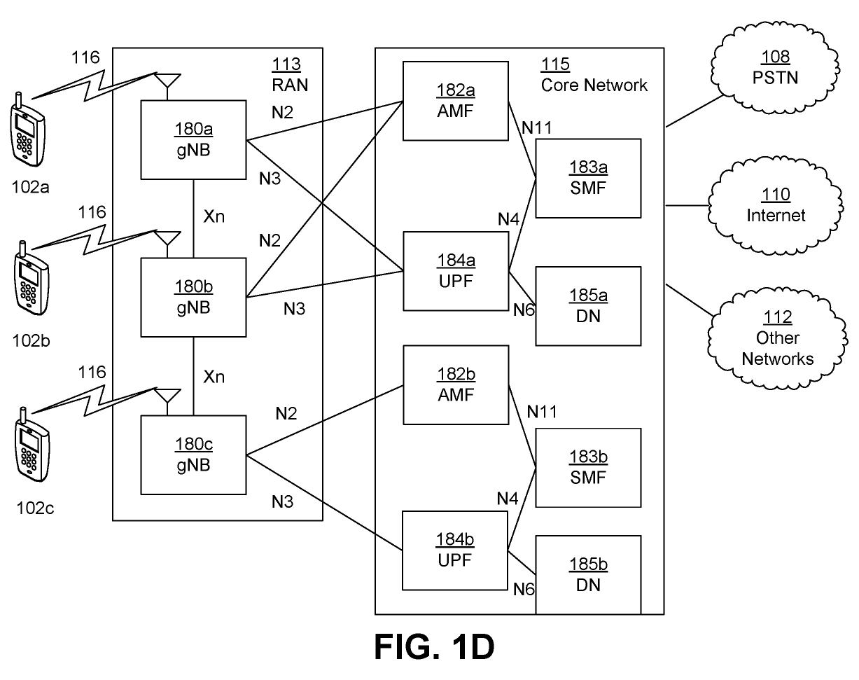

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a,102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access , which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a,102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc. and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c,102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a,180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b,180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b,102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a,102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Framework for supporting use cases may include wireless transmit/receive unit (WTRU)-side and/or network (NW)-side data collection. Data collection may be performed for purposes in life cycle management (LCM), for example for model training, model inference, model monitoring, model selection, and/or model update. Example purposes may have different requirements and/or potential specification impact.

Data collection may be used for training of a network side or a WTRU sided model. Data may be collected for the training of a network sided model, for example based on (e.g., immediate) minimization of drive test (MDT) (e.g., sent via RRC signaling). Additionally, or alternatively, a low priority signaling radio bearer (SRB) may be used. A WTRU may send an availability indication when data is available. A network may request the collected data on demand (e.g. using UEInformationRequest/response messaging). Large amounts of data may be sent, for example in multiple requests, and/or one request followed by multiple responses, etc. A WTRU may stop/pause the data collection when a buffer limit is reached. A WTRU may indicate to the network before/when the buffer becomes full (e.g., a percentage of buffer size). A WTRU may send an indication of a power problem and/or to stop/pause the data collection. Periodic and/or event based logging may be supported (e.g., events based on radio conditions).

Data may be collected for the training of a WTRU sided model. For example a WTRU may collect and/or (e.g., directly) transfer training data to an over-the-top (OTT) server. The OTT server may be transparent or non-transparent. A WTRU may collect training data and/or transfer the training data to a core network (CN). The CN may transfer the training data to the OTT server. A WTRU may collect training data and/or transfers it to operations, administration, and maintenance (OAM). OAM may transfer the (e.g., needed) data to the OTT server.

There may be mobility, for example in NR. Handover may be triggered by a measurement report. Additionally, or alternatively, the network may send a handover (HO) commence to a WTRU, for example without receiving a measurement report (e.g., for load balancing purposes).

The WTRU may be configured with a measurement object and/or a reporting configuration. The measurement object may indicate what is being measured, for example frequency, cells, the quantity being measured, RSRP, and/or RSRQ, etc. The reporting configuration may indicate what is being reported (e.g., reference signal type such as CSI-RS or SSB, the beam and cell level quantities to be reported such as RSRP/RSRQ, maximum number of cells and/or beams to be reported, etc.) and/or reporting criteria (e.g., periodic, and/or event conditions). The WTRU may send a measurement report, for example when the reporting criteria and/or reporting is fulfilled. Fulfilled and satisfied may be used interchangeable herein.

A WTRU can be configured with one or more events. Example events may include event A1, event A2, event A3, event A4, event A5, event A6, event B1, and/or event B2. Event A1 may include a serving cell becoming better than a threshold. Event 2 may include a serving cell becoming worse than a threshold. Event A3 may include a neighbor cell becoming an offset better than an SpCell. Event A4 may include a neighbor cell becoming better than a threshold. Event A5 may include an SpCell becoming worse than a first threshold (e.g., threshold1) and a neighbor cell becoming better than a second threshold (e.g., threshold2). Event A6 may include an neighbor cell becoming better than an SCell. Event B1 may include an inter RAT neighbor cell becoming better than a threshold. Event B2 may include a PCell becoming worse than a first threshold (e.g. threshold1) and an inter RAT neighbor cell becoming better than a second threshold (e.g., threshold2).

The term SpCell may refer to a primary cell (PCell) and/or a primary secondary cell (PSCell). For example SpCell may refer to the PSCell for dual connectivity (DC). Event A3, A5, and/or B2 may be configured for the PCell and/or PSCell. Events A1, A2, A3, A5, and/or B2 may be configured for any serving cell. Event A6 may be configured for SCells (e.g., for the secondary cells in carrier aggregation (CA). Events A4 and/or B1 may be related to cell measurements and/or not be related to any serving cell.

The WTRU may be configured with a trigger for an (e.g., example) event. A WTRU may be configured with an A3 event that may trigger a measurement report to be sent when the radio signal level/quality (RSRP, RSRQ, etc) of a neighbor cell becomes better than the PCell and/or the PSCell, for example for DC. The WTRU may monitor the serving and/or neighbor cells. The WTRU may send a measurement report when the condition(s) and/or event(s) are fulfilled. The network may receive the report. When the network receives the report for example, the network may prepare a HO command. The HO command may include an RRC Reconfiguration message, for example with a reconfigurationWithSync. The WTRU may send the HO command to the WTRU, for example based on the event. The WTRU may execute the HO command, which for example may result in the WTRU (e.g., immediately) connecting to the target cell.

Conditional handover (CHO) may reduce the likelihood of radio link failures (RLF) and/or handover failures (HOF). In CHO for example, the WTRU may be preconfigured with a CHO command and/or an associated event (e.g., similar to measurement reporting). The WTRU may execute the CHO command (e.g., instead of sending a measurement report), for example when the event condition(s) are fulfilled.

A WTRU may be configured with one or more events for CHO. Example events may include CondEvent A3, CondEvent A4, and/or CondEvent A5. CondEvent A3 may include a conditional reconfiguration candidate becoming an offset amount better than a PCell and/or PSCell. CondEvent A4 may include a conditional reconfiguration candidate becoming better than a threshold, for example an absolute threshold. CondEvent A5 may include a PCell and/or PSCell becoming worse than a (e.g., absolute) first threshold (e.g., threshold1) and/or a conditional reconfiguration candidate becoming better than a (e.g., absolute) second threshold (e.g., threshold2).

Buffering data belonging to SRBs may be flushed, for example during mobility (e.g., HO). Additionally, or alternatively, buffering data belonging to DRBs may be maintained and/or transmitted at the target cell (e.g., mobility may be lossless for DRBs). Handling (e.g., requirements) for collected data for some purposes (e.g., for the training an AI/ML model) may not be aligned data handling (e.g., requirements) for SRBs and/or DRBs during mobility. If the collected data from the WTRU is to be trained at certain entity/server that is not accessible/reachable via the target cell/gNB for example (e.g., due to issues like privacy/legal restriction, if the source and/or target cells belong to different operators/PLMNs, and/or even crossing country/regional boarders, etc.), training may not be desirable and/or possible. If there is no (e.g., such) limitation/restrictions to connectivity with the training entity/server for example, (e.g., then) maintaining the collected data at WTRU and/or sending the collected data via the target cell/gNB may be desirable. The WTRU may send the collected data(at a later and/or more opportune time, for example including more data that is collected at the target location.

Systems and methods may include enhancements regarding handling of collected data during mobility. For example systems and methods may include enhancements for how to handle collected data for AI/ML model training during mobility.

A WTRU may be configured to collect/log data (e.g., for the training of an AI/ML model). The WTRU may be additionally or alternatively configured with how to handle the collected data pending to be sent during mobility (e.g., HO, CHO, and/or recovery from failure, etc.). For example the WTRU may include a configuration which indicates a set of conditions that may be fulfilled to maintain the collected data, discard the collected data, and/or maintain the collected data temporarily. For example the WTRU may be configured to maintain collected data until a certain time has elapsed and/or the WTRU goes back to a cell where the data is relevant (e.g., becomes relevant again). Upon mobility for example, the WTRU may check the condition(s) associated with collected data handling. The WTRU may apply a behavior, for example corresponding to the condition(s) associated with collected data handling.

The WTRU may receive configuration information. The configuration information may include a first data collection configuration (e.g., RRC message). The (e.g., first) configuration may include the data to be collected (e.g., measurement configuration), a configuration related to an associated bearer (e.g., DRB, and/or low priority SRB) to be used for reporting the collected data, and/or a (e.g., first) set of conditions/events related to performing data logging/collection (e.g., starting conditions, stopping conditions, and/or logging conditions, etc.).

The configuration information may include a second configuration. For example, the second configuration may be received in a different message than the first configuration or may be received in the same message as the first configuration. The (e.g., second) configuration may include a set of conditions/events for determining if pending collected data is maintained, discarded, and/or maintained temporarily. The (e.g., second) configuration may indicate a relevancy of the data in the target cell (e.g., cell group or area configuration indicating the validity area of the collected data), a mobility type (e.g., legacy mobility, CHO, and/or recovery from RLF via CHO/LTM, etc.), and/or a volume of collected data. Additionally, or alternatively, the WTRU may determine if the collected data is maintained, discarded, and/or maintained temporarily based on a relevancy of the data in the target cell (e.g., cell group or area configuration indicating the validity area of the collected data), a mobility type (e.g., legacy mobility, CHO, and/or recovery from RLF via CHO/LTM, etc.), and/or a volume of collected data.

The WTRU may check the (e.g., second) set of conditions, for example upon performing HO (e.g., HO command received, CHO conditions fulfilled, and/or recovery via LTM/CHO after RLF, etc.). If the conditions for maintaining the collected data are fulfilled for example, the WTRU may maintain the collected data upon/after mobility. If the conditions for discarding the collected data are fulfilled for example, the WTRU may discard the collected data. If the conditions for maintaining the data temporarily are fulfilled for example, the WTRU may maintain the data temporarily (e.g., suspends the bearer associated with the data collection, and/or stores the data in WTRU variable(s), etc.). The WTRU may start a timer (e.g., validity timer), for example if the conditions for maintaining the data temporarily are fulfilled. A timer value may indicated in the second configuration.

The WTRU may execute the HO. The WTRU may send a HO complete message, for example to the network. The HO complete message may indicate whether/if collected data is maintained, discarded, and/or maintained temporarily. The network may later prioritize a cell where the data may be useful, for example if the HO complete message indicates that the collected data is maintained temporarily. The HO message may include additional information, for example time remaining and/or possible target cells where the data may be relevant. Additionally, or alternatively, the network may determine a time remaining and/or possible target cells where the data may be relevant.

If collected data was maintained temporarily for example, the WTRU may perform a (e.g., subsequent) mobility back to the source cell and/or any other cell that is within the validity area of the collected data (e.g., before the validity timer expires). If the WTRU performs a (e.g., subsequent) mobility back to the source cell and/or any other cell that is within the validity area of the collected data (e.g., before the validity timer expires), the WTRU may restore the collected data. For example the WTRU may restore the collected data by resuming the bearer associated with the data collection and/or transferring the data that is in a WTRU variable to a bearer associated with the data collection, etc. The WTRU may (e.g., otherwise) discard the collected data and/or send an indication that that data is discarded (e.g., immediately or in a subsequent uplink (UL) control message). For example the WTRU may discard the collected data and/or send an indication that that data is discarded if the WTRU performs a (e.g., subsequent) mobility back to the source cell and/or any other cell that is within the validity area of the collected data (e.g., before the validity timer expires) and/or if collected data was maintained temporarily.

Systems and methods may provide consistency between training and inference. A (e.g., given) AI/ML model may be trained under (e.g., certain) WTRU and/or network side conditions. For example, a WTRU side condition may include a speed of the WTRU. Network side conditions may be related to network configurations/settings, for example that the WTRU may not be aware and/or may impact the performance of the model. For example, an RLF prediction model may perform differently if the model was trained when the network was using a certain antenna pattern, beam pattern, and/or power level, etc. There may be aspects related to network load, that for example may impact model performance.

The WTRU may not need and/or have details of the network side conditions. For example, the network may not provide (e.g., some) details. The network may hide these details, for example by signaling to the WTRU one or more associated ID(s). For example, when data is being collected for training a model, tagging may be performed. The tagging may indicate under which network side conditions the model is being trained. Before a WTRU is configured to perform an operation based on an AI/ML model for example (e.g., measurement prediction), the WTRU may be configured to check the consistency between condition. For example the WTRU may be configured to check the consistency between the conditions under which the AI/ML model is trained and current conditions (e.g., current WTRU conditions, and/or current associated ID(s) signaled by the network indicating current network conditions/settings, etc.).

The term life cycle management (LCM) may be used to describe (e.g., overall) management aspects of AI/ML models. Example management aspects of AI/ML models may include model training, functionality/model identification, model delivery/transfer, model inference operation, functionality/model monitoring, model update, WTRU capability, data collection (for model training, for monitoring, for inference, etc.), and/or functionality/model selection, activation, deactivation, switching, and/or fallback operation. Functionality/model selection, activation, deactivation, switching, and/or fallback operation may include a decision by the network (e.g., either network initiated or WTRU-initiated and requested to the network), and/or a decision by the WTRU (e.g., event-triggered as configured by the network, WTRU’s decision reported to the network, and/or WTRU-autonomous either with WTRU’s decision reported to the network or without it).

LCM may be functionality-based LCM and/or model-ID based LCM. In functionality-based LCM for example, a network may indicate activation/deactivation/fallback/switching of AI/ML functionality. For example the network may indicate activation/deactivation/fallback/switching of AI/ML functionality via 3GPP signaling (e.g., RRC, MAC-CE, DCI). Models may not be identified at the network in some examples. A WTRU may perform model-level LCM, for example if the models are not identified at the network. The WTRU may have one AI/ML model for a functionality or the WTRU may have multiple AI/ML models for the functionality.

In model-ID-based LCM for example, models may be identified at the network. The network/WTRU may activate/deactivate/select/switch individual AI/ML models, for example via model identifier (ID). In the functionality based LCM for example, the WTRU may choose the AI/ML model to use for a certain functionality. The network may determine for which functionalities the WTRU may use AI/ML based operation. The WTRU may (e.g., then) determine the AI/ML model to use, for example based on the network determination of for which functionalities the WTRU may use AI/ML based operation.

In the model-ID based LCM for example, the network may (e.g., explicitly) control which (e.g., particular) model may be used for a given AI/ML functionality. For example, the WTRU may provide details of AI/ML models and/or capabilities. The network may determine which model to activate for a particular functionality.

Systems and methods herein may be applicable to (e.g., both) model-ID based and/or functionality-based LCM. Systems and methods may be related to how the WTRU may determine whether the WTRU has a model that is applicable for the indicated associated ID(s). For example for functionality-based LCM, the WTRU may be configured/requested to determine if a given functionality is valid/applicable. The WTRU may determine if the (e.g., given) functionality is valid/applicable determination among (e.g., all) the models that the WTRU has. The WTRU may determine that the functionality is applicable, for example if at least one of the models is applicable. For model-ID based LCM for example, the WTRU may be configured/requested by the network to determine whether a particular model is applicable or not. An associated identifier (ID) may be specific to a given functionality and/or the ID may be applicable/common to more than one and/or functionalities.

The WTRU may support several AI/ML models for a given functionality, for example with different prediction time horizons, prediction confidence levels, processing requirements, and/or trained under/for operation in different frequencies/cells/location/times of day, etc. An (e.g., given) AI/ML model for a certain functionality may operate in different modes (e.g., with different levels of prediction confidence levels at different prediction time horizons, at different locations, frequencies, and/or WTRU mobility pattern/speed, etc.). The AI/ML models may be available at the WTRU already trained or the WTRU may be provided with an untrained AI/ML model. The WTRU may train a model, for example an untrained model. In some examples the WTRU may further train a trained model.

The AI/ML model may be available at the WTRU already trained, and the WTRU may be enabled/configured to perform further training (e.g., for different conditions such as frequencies/cells/location/times of day, for the same conditions as the initial training but for increasing the level of confidence and/or the prediction time horizon, and/or for different WTRU speeds, etc.). The AI/ML model may be available at the WTRU but not trained at all or only trained for certain WTRU/network conditions. The WTRU may be configured to train the model (e.g. for the conditions that it is not trained for).

In some examples, the WTRU may utilize some configurations/inputs for performing the inference using an AI/ML model. For example for radio signal level prediction, the WTRU may be configured with a certain number of beams/cells to measure to determine the prediction. In some examples, the WTRU may communicate a requested (e.g., required) configuration/input as part of the capability information. Additionally, or alternatively, the WTRU may communication a requested (e.g., required) configuration/input to the network after a capability request (e.g., based on explicit network request, if the WTRU gets configured to do AI/ML based measurement predictions, and/or the WTRU has determined that it is lacking the required configuration/input, etc.).

A WTRU may be configured to collect data, that for example may be used for training of an AI/ML model. In some examples the WTRU may not be configured to perform AI/ML based operations. The data to be collected may be used for a training a network sided model, a WTRU sided model, or the WTRU and/or network sides of a two-sided model (e.g., a CSI compression model where there is an encoder model at the WTRU and a corresponding decoder model on the network side).

Systems and methods herein may be applicable to (e.g., any kind of) data collection that is performed for other purposes than a training of an AI/ML model, for example sensing and/or application layer performance monitoring. Systems and methods herein may be applicable to data not related to data collection, for example applications that may have similar needs to data collection (e.g., by default having no latency and/or bit rate requirements but with the requirements changing based on some conditions). Systems and methods herein may be applicable to a (e.g., any) data collection architecture, for example regardless of the destination server for the data (e.g., within the RAN, in the CN, within the operator’s network outside the RAN/CN, and/or outside the operator’s network). The terms functionality and procedure may be used interchangeably. The terms data, measurement(s), report(s), and/or result(s) may be used interchangeably. The terms logging and collecting may be used interchangeably. Other associated terms such as like logged data and collected data, etc. may be used interchangeably. The terms indication, information, command, and/or message may be used interchangeably. The terms handover and mobility may be used interchangeably.

Systems and methods may include a (e.g., general) data collection configuration. The (e.g., general) data collection configuration may be included in configuration information. The WTRU may receive the data collection configuration (e.g., configuration information) from the network (e.g., gNB, LMF, CN, OAM, NWDAF, and/or any Network Function (NF) within the operator’s network) and/or from outside the network (e.g., OTT server). The WTRU may request a measurement configuration from the network, for example if the data collection configuration is from outside of the network. The WTRU may request the measurement configuration from the network to (e.g., be configured to) gather the required information.

The WTRU may receive a data collection configuration (e.g., configuration information). The data collection configuration may include one or more of that may include one or more of information/measurement to be logged, (e.g., additional) information the WTRU may include in the measurements (e.g., timestamps, location/cell information, associated IDs, and/or WTRU side conditions, etc.), a logging periodicity, logging events/conditions (e.g., radio conditions that may be fulfilled for the logging to be performed, times of the day for the logging to be performed, and/or areas/cells where the logging is to be performed, etc.), information regarding when logging is to be started (e.g., immediately, after a certain time delay, at an absolute time in the future, when WTRU goes into certain area/cell, etc.), information regarding when logging is to be stopped/paused (e.g., when the amount of collected data reaches a certain buffer threshold, when a certain number of samples have been collected, etc.), information regarding when collected data may or may not be reported to the network (e.g., specific time window during which collected data may be sent or may not be sent, and/or may be done dynamically via an explicit indication to start/stop sending the collected data, as discussed herein), and/or information related to the data destination (e.g., RAN, CN, OAM, another NF, OTT server, etc.), etc.

A data collection configuration may be referred to as a data collection process herein. When a data collection process is not ongoing for example, this may refer to and/or result in the data collection configuration being deactivated and/or released. The data collection configuration may be related to a certain higher usage level (e.g., sensing, AI/ML operation, etc.) and/or may be at a detailed granularity level for example different data collection configurations for the training of models for different AI/ML functionalities and/or sub functionalities (e.g., one for CSI compression, one for temporal beam/cell measurement prediction, and/or one for spatial beam/cell measurement prediction, and/or one for positioning, etc.)

Multiple data collection configurations may be provided to the WTRU, for example separately. A (e.g., each) data configuration may configure different measurements/information to be gathered and/or may have different detailed information/parameters regarding the given data collection configuration. Additionally, or alternatively, all or a subset of the configuration may share some of the configuration elements (e.g., may have a common periodicity, similar additional information to add to the measurements, and/or stopping/reporting conditions, etc.) and/or may have separate configuration elements (e.g., the measurement to be performed, events for logging, and/or buffer level thresholds, etc.).

There may be an association of data collection bearers and logical channels. The WTRU may receive a configuration regarding how the collected data based on the received configuration is to be mapped to an associated bearer and logical channel. The associated bearer may be referred to as data collection bearer herein. The associated logical channel may be referred to as data collection logical channel herein.

The mapping may be according to one or more of one data collection bearer/logical channel for all data collection configurations, separate data collection bearer/logical channel for each data collection configuration, separate data collection bearer/logical channel for different types of data collection (e.g., one for data collection for AI/ML model training, and/or one for data collection for sensing, etc.), separate data collection bearers/logical channels for different data termination points/destinations (e.g., one for data destined at a RAN entity/network function, one for data destined at CN entity/network function, one for data to be collected at the OAM, and/or one for data to be collected at an OTT server outside the operator’s network, etc.), and/or multiple bearers/logical channels. Additionally, or alternatively, bearers may be mapped according to the need/requirements of the collected data, for example for multiple bearers/logical channels. For example, higher priority/quality collected data based on different data collection configurations may be sent via one bearer/logical channel and/or low priority collected data may be sent based on a different data collection configuration.

A data collection configuration(s) may be mapped to a data radio bearer (DRB) and/or a signaling radio bearer (SRB). The terms data collection bearer, collected data bearer, data collection logical channel, and/or logical channel for data collection may be used interchangeably herein.

There may be conversion of collected data samples into PDCP SDUs. In an NR protocol stack for example, for DRBs a PDCP may receive IP packets (e.g., PDCP SDUs). If the collected data is to be sent via a DRB for example, (e.g., then) the collected data (e.g., from a WTRU variable) may be mapped into a PDCP SDU. Mapping of the collected data into a PDCP SDU may include a (e.g., each) sample of logged data converted to one PDCP SDU, a certain (e.g., configured value) number of samples multiplexed into one PDCP SDU, and/or (e.g., all) samples that may fit into a maximum size of a PDCP SDU (e.g., 9000 bytes or some other maximum value defined for data collection bearers) grouped together into one PDCP SDU and/or any leftover samples fit into a smaller PDCP SDU (e.g., the WTRU will minimize the total number of PDCP SDUs to be sent).

The WTRU may store the collected data, for example temporarily in a WTRU variable. The WTRU may (e.g., then) push the data to the PDCP of the bearer associated with the data collection. There may be one or more WTRU variables associated with (e.g., different) data collection processes. For example there may be several WTRU variables associated with different data collection processes (e.g., data collection for training of AI/ML models for different functionalities, and/or data collection for sensing, etc.). A (e.g., each) variable may have associated (e.g., different) configuration parameters. For example configuration parameters may include maximum size limit, and/or maximum time limit to store the data, etc.

The WTRU may transfer the stored data. The WTRU may transfer the stored data from the WTRU variable to the PDCP of the bearer associated with the WTRU variable, for example upon the fulfillment of some condition(s) (e.g., when the maximum size limit is reached, when a maximum time limit is reached, and/or upon explicit request from the network or external entity/server, etc.).

The WTRU may delete data, for example that has been transferred to the PDCP of the associated bearer. Additionally, or alternatively, the WTRU may transfer a certain amount of data (e.g., periodically, and/or every x samples or every x bits, etc.) to the associated PDCP, for example such that the amount of data remaining in the WTRU variable does not surpass a certain maximum (e.g., threshold) level. The WTRU may transfer a certain sample of data, a certain number of samples, and/or a certain number of bits of data, for example depending on the age of the data collected. For example, the WTRU may transfer data samples that are older than a certain configured time threshold, etc.

Systems and methods may maintain/discard collected data based on a source and/or target cell. A WTRU may maintain the collected data in a source cell and/or upon/after mobility to a target cell, for example if the source and target cell are configured to be within the same data collection domain/relevance.

A WTRU may consider a source and target cell to be in the same data collection domain if one or more criteria are fulfilled. Example criteria may include the source and target cell belonging to the same public land mobile network (PLMN), the source and target cell having the same associated identifier (ID), and/or the source and target cell belonging to the same RAN area and/or tracking area. An additional or alternative example criteria may include the WTRU being configured with a grouping of cells, for example as part of the data collection configuration. The cells may belong to the same group and/or the same data collection domain. The source cell and target cell may belong to the same group. An indication of the cells belonging to the same group and/or the same data collection domain and/or the source cell and target cell may belonging to the same group may be included in the configured grouping of cells. An additional or alternative criteria may include an indication in the HO command that may specify if the target cell is within the same data collection domain as the source cell.

The example criteria herein may be the same for (e.g., all) data collection bearers/logical channels and/or may be different for a (e.g., each) bearer/logical channel. For one bearer/logical channel (LCH) associated with data collection for example, the WTRU may maintain the data if the source and target belong to the same PLMN and/or tracking/RAN area. For another bearer/LCH for example, the WTRU may maintain the data even if the two cells have different PLMNs and/or tracking/RAN areas. The WTRU may be configured with multiple cell groupings for data collection relevance, for example where each grouping may be specific to a given data collection bearer/LCH and/or a subset of the data collection bearers/LCHs. The WTRU may receive a HO command that specifies for which data collection bearers/logical channels the collected data should be maintained and/or for which data collection bearers/logical channels the collected data should be discarded.

Systems and methods may maintain/discard collected data based on one or more conditions related to collected data. The WTRU may modify the collected data handling during mobility, for example depending on the volume of the collected data that is pending to be sent for the data collection logical channel. If the volume of collected data pending to be transmitted at the upon/after mobility is greater than a certain threshold (e.g., absolute threshold, a percentage of the maximum buffer allocated for the data collection, etc.) for example, the WTRU may discard the collected data. If the volume of collected data pending to be transmitted at the upon/after mobility is less than a certain threshold (e.g., absolute threshold, a percentage of the maximum buffer allocated for the data collection, etc.) for example, the WTRU may maintain the data. For example the WTRU may maintain up to a configurable maximum size of collected data (e.g., number of samples, and/or actual number of bits, etc.) after the mobility. The WTRU may be additionally or alternatively configured with criteria indicating which part of the collected data to discard, for example to reach the configured maximum size (e.g., in case more data than the configured maximum size was available. For example, the WTRU may discard the oldest data samples removed until the size criteria is fulfilled.

The WTRU may modify the collected data handling during mobility, for example depending on time related information concerning the collected data or the data collection process. The WTRU may maintain the data, for example if the data collection process associated with the data collection logical channel is still ongoing (e.g., if the WTRU is going to keep the data collection/logging in the target cell). Alternatively, or additionally, the WTRU may be configured to discard the data, if the data collection process associated with the data collection logical channel is still ongoing (e.g., if the WTRU is going to keep the data collection/logging in the target cell). Discarding the data may result in newer (e.g., fresher) data in the target (e.g., cell).

The WTRU may maintain the data, for example if the data collection process associated with the data collection logical channel has stopped (e.g., before mobility, and/or upon mobility, etc.). Additionally, or alternatively, the WTRU may maintain the data based on a timer. For example the WTRU may maintain the data if the data collection has been stopped for not more than a certain duration (e.g., of a timer). The WTRU may discard the data if the data collection has been stopped for more than the duration (e.g., of the timer). The WTRU may discard the data that is older than a certain duration (e.g., of the timer).

The WTRU may maintain the data, for example if the WTRU was in the process of reporting the collected data when mobility was triggered. The WTRU may discard the data, for example if the collected data is older than a certain configured time duration. For example the age of the collected data may be determined based on the time the data collection started, the time the oldest data sample was logged, the time the latest data sample was logged, and/or the average time of logging of the samples, etc. The WTRU may discard the data, for example depending on a deadline configured/associated with the data collection. For example the WTRUI may discard the data if the deadline has already passed and/or if the deadline is less than a configured absolute/percentage duration away, etc. In some examples the WTRU may (e.g., otherwise) discard the data.

The example criteria herein may be the same for (e.g., all) data collection bearers/logical channels and/or may be different for a (e.g., each) bearer/logical channel. For one bearer/LCH associated with data collection for example, the WTRU may maintain the data regardless of the volume of collected data. For another bearer/LCH for example, the WTRU may maintain a maximum configured volume (e.g., threshold) of data. The WTRU may discard data samples older than an (e.g., first) absolute/relative time for one example bearer/LCH. The WTRU may discard data samples older than an absolute/relative time for another example bearer. For another example bearer/LCH, the WTRU may not have data age related criteria for discarding the data. The WTRU may discard the collected data for a (e.g., one) bearer/LCH, for example if the data collection process associated with the bearer/LCH is ongoing. The WTRU may maintain the collected data for a (e.g., another) bearer/LCH, for example if the data collection process associated with another bearer/LCH is ongoing, etc.

Systems and methods may maintain data for a given time configured time duration, for example a threshold time. The WTRU may discard the data, for example if the data is determined to be not relevant in the target cell. For example, the data may be determined to not be relevant in the target cell based on the one or more (e.g., data collection relevance) criteria (e.g., described herein).

However, there may be scenarios where maintaining data, for example certain data, may be desirable. For example the WTRU may (e.g., initially) perform handover from cell A to B, and then handover to cell C within a (e.g., relatively short) period of time. Cell C may be the same as cell A or may be another cell, for example in the same data collection relevance/domain of cell A (e.g., for one or more data collection logical channels). Maintaining the data may be desirable as the data may be relevant to cell C.

The WTRU may be configured with a time duration (e.g., timeToDiscardDuration). If for example the WTRU determines that the source and target cell are not within the same data collection domain/relevance, the WTRU may start a timer (e.g., timeToDiscard). The WTRU may start the timer (e.g., timeToDiscard) with the configured time duration value (e.g., timeToDiscardDuration). The WTRU may maintain the data, for example while the timer (e.g., timeToDiscard) is running and/or may discard the data if the timer expires before the WTRU moves back to the original source cell and/or an area/cell of the same data collection domain/relevance as the original source cell.

The time duration and/or timer may be configured at a bearer/logical channel level and/or may be common for other (e.g., all) data collection bearers/logical channels. For some bearers/logical channels the time duration and/or timer may be configured for example. Additionally, or alternatively, for other data collection bearers/logical channels the WTRU may (e.g., immediately) discard the data, for example upon determining that the source and target are not of the same data collection domain/relevance, etc.

While the (e.g., timeToDiscard) timer is running for example, the WTRU may suspend the corresponding bearer/logical channel (e.g., the PDCP stops transmitting PDUs to the lower layers and/or does not include the concerned data in the data volume calculations, etc.). The WTRU may be configured to suspend the corresponding data collection process, for example while the (e.g., timeToDiscard) timer is running. Additionally, or alternatively, the WTRU may continue collecting the data and/or store collected data in a (e.g., another) WTRU variable and/or instance of WTRU variable. If the timer expires for example, the WTRU may delete the data belonging to the old WTRU variable and/or maintaining the data in the new WTRU variable, etc. In some examples the WTRU may not use two WTRU variable instances and/or may delete (e.g., all) the data that was logged before the handover. For example the WTRU may delete the data that contains/indicates the source cell (e.g., with a field), etc.

The WTRU may discard some of the data. For example the WTRU may partially discard data upon the timer expiry. The WTRU may perform a partial discard of any of the data and/or based on any of the criteria as herein. For example the WTRU may discard a certain amount of the collected data to maintain a given configured maximum buffer size, etc.

Systems and methods may maintain/discard collected data based on a mobility type. The WTRU may apply one or more of the above behavior, for example corresponding to the condition(s) (e.g., as herein). The WTRU may apply the behavior, for example depending on the mobility type. The mobility type may be one or more of (e.g., legacy) HO, CHO, cell switching, and/or recovery from radio link failure (RLF). The (e.g., legacy) HO may be during a reception of a HO command form the network. Conditional handover (CHO) may be triggered by the WTRU, for example upon the fulfillment of some event(s). Cell switching may be due to a reception of a L1/L2 triggered mobility (LTM) MAC control element (CE). Recovery from a radio link failure may be via RRC re-establishment and/or by executing a pre-configured CHO/LTM configuration, etc.

The WTRU maintain collected data belonging to one or more logical channels, for example if the mobility was due to LTM. Additionally, or alternatively, the WTRU may discard the data and/or conditionally discard the data (e.g., based on the one or more conditions as herein), for example if the mobility was due to CHO.

The WTRU may maintain, discard, conditionally maintain, or conditionally discard collected data (e.g., as described herein) and/or threshold/parameters used for different mobility cases/types may be different. For example when frequent cell switches are expected, a shorter discard duration (e.g., timer) may be configured. The shorter discard duration (e.g., timer) may be configured for example in an LTM context. For example when less frequent cell switches are expected, a longer discard duration (e.g., timer) may be configured. The longer discard duration (e.g., timer) may be configured for example in a CHO context.

The WTRU may be pre-configured with one or more of the conditions/thresholds (e.g., as herein), for example regarding the maintenance/discard of collected data. Additionally, or alternatively, the WTRU may receive an indication that may override the pre-configuration. The WTRU may receive the indication for example in an HO command (e.g., legacy HO command, in the LTM cell switch MAC CE, etc.). For example the HO command may indicate that data should be discarded and/or the pre-configuration may indicate that data should be maintained. In some examples, the HO command may indicate that data should be maintained and/or the pre-configuration may indicate that data should be discarded.

Systems and methods may maintain and/or discard certain data. Discarding data, for example related to a data collection bearer, as herein may refer to discarding data, discarding data in the WTRU variable, maintaining data still in the WTRU variable, and/or maintaining the data in the WTRU variable and/or the packet data convergence protocol (PDCP) service data units (SDUs). The WTRU may discard all of the data, for example including data that may be stored in a WTRU variable and not yet transferred to the PDCP of the associated bearer. The WTRU may discard all of the data in the WTRU variable (e.g., not yet transferred to PDCP of the bearer yet) and/or maintain the rest of the data. The WTRU may maintain all of the data in the WTRU variable (e.g., not yet transferred to PDCP of the bearer) and/or discard the rest of the data (e.g., the PDCP SDU, and/or associated PDCP/RLC PDUs, etc.). The WTRU may maintain all of the data in the WTRU variable and/or the PDCP SDUs and/or discard the rest of the data (e.g., associated PDCP/RLC PDUs, etc.)

The WTRU may indicate an applied behavior (e.g., as herein) regarding collected data, according to any of the conditions and/or solutions discussed herein, for example upon the completion of the handover. The WTRU may send an indication to the target cell (e.g., in the HO complete message, in a separate message, etc.). The indication may indicate whether and/or if collected data should be maintained and/or discarded. For example, the indication may be simple indication or a detailed indication. An example detailed indication may include information about each logical channel/bearer whose data is to be maintained and/or discarded, and/or the amount of data maintained and/or discarded, etc.).

The WTRU may send a request to the network, for example before discarding the data. Additionally, or alternatively, the WTRU may discard data upon a confirmation from the network. The WTRU, for example upon determining to discard the data for one or more logical channels/bearer according to any of the conditions and/or solutions herein, may send a request to the network before discarding the data and/or may discard the data upon a confirmation from the network. For example, the WTRU may send a message to the network. The message may include a request to discard the data. The network may respond to the WTRU with a message including an indication to not to discard the data, to discard the data, and/or to discard some of the data. For example, the network may send a message including an indication to the WTRU to discard the data associated with one bearer/logical channel and/or maintain the data associated with another bearer/logical channel, etc.

There may be generalization to (e.g., other) protocol stacks/architectures. Systems and methods herein may utilize a NR protocol architecture for single connectivity, for example with no duplication or split bearer operation. For example, for each bearer there may be one PDCP entity, one RLC entity, and/or one logical channel. A WTRU may have a single MAC entity. However, systems and methods herein may additionally, or alternatively, utilize other protocol architectures and/or bearer to logical mappings (e.g., in 6G). For example, systems and methods may be utilized for a bearer-less operation (e.g., each packet containing header information that may be used by the MAC for LCP operation), a many-to-many mapping between bearers and logical channels (e.g., one bearer mapped to multiple logical channels even though there is no legacy split bearer or duplication being performed, and/or one logical channel mapped to multiple bearers, etc.), a user plane (UP) protocol stack that may not include the RLC (e.g., PDCP sitting directly above MAC), and/or a separate data plane protocol stack (e.g., that may have its own logical MAC entity). For example (e.g., all) the logical channels for data collection may be associated with the separate data plane protocol stack.

Solutions and/or conditions herein may apply to any of the cases and/or behaviors as herein. For example, a solution and/or condition may be specified at a data plane (DP) level configuration. The DP level configuration may be applicable to (e.g., all) logical channels in the stack. The DP level configuration may be provided in addition to or alternative to a solution and/or condition at a bearer/logical channel level.

1. A wireless transmit/receive unit (WTRU) comprising:
a processor, the processor configured to:
receive configuration information, wherein the configuration information comprises one or more first conditions associated with collected data;
determine to perform handover (HO) from a first cell to a second cell;
in response to the determination to perform HO from the first cell to the second cell, determine whether the one or more first conditions associated with the collected data are satisfied;
perform HO to the second cell; and
in response to the performance of HO to the second cell and based on the determination of whether the one or more first conditions associated with collected data are satisfied, perform one or more of the following:
maintain the collected data;
discard the collected data; or
maintain the collected data for a predetermined time.

2. The WTRU of claim 1, wherein the one or more first conditions comprise at least one of a condition for maintaining the collected data, a condition for discarding the collected data, or a condition for maintaining the collected data for the predetermined time, and wherein the processor is configured to perform one or more of the following:
maintain the collected data based on a determination that the condition for maintaining collected data is satisfied;
discard the collected data based on a determination that the condition for discarding the collected data is satisfied; or
maintain the collected data for the predetermined time based on a determination that the condition for maintaining the collected data for the predetermined time is satisfied.

3. The WTRU of claim 1, wherein the processor is configured to send a HO complete message to a network, the HO complete message comprising an indication of one or more of the collected data being maintained, the collected data being discarded, or the collected data being maintained for the predetermined time.

4. The WTRU of claim 1, wherein the processor is configured to perform one or more of the following:
receive a HO command from a network and determine to perform the HO to the second cell based on the HO command from the network; or
determine to perform the HO to the second cell based on one or more conditional handover (CHO) conditions being satisfied.

5. The WTRU of claim 1, wherein the one or more first conditions comprises an indication of whether the first cell and the second cell are in a same data relevancy domain, and wherein the processor is configured to determine to perform one or more of the following:
maintain the collected data, discard the collected data, or maintain the collected data for a predetermined time based on a determination of whether the first cell and second cell are in the same data relevancy domain.

6. The WTRU of claim 5, wherein the processor is configured to perform one or more of the following:
maintain the collected data based on a determination that the first cell and the second cell are in the same data relevancy domain;
discard the collected data based on a determination that the first cell and the second cell are not in the same data relevancy domain; or
maintain the collected data for the predetermined time based on a determination that the first cell and the second cell are not in the same data relevancy domain.

7. The WTRU of claim 5, wherein the processor is configured to maintain the collected data for a predetermined time and to discard the collected data based on a determination that the predetermined time has elapsed after the performance of the HO to the second cell and based on a determination that the WTRU has not performed a second HO to one or more of the first cell or to a third cell, the third cell being in a same data relevancy domain as the first cell.

8. The WTRU of claim 1, wherein the one or more first conditions comprises a mobility type, and wherein the processor is configured to determine whether the one or more first conditions associated with the collected data are satisfied based on the mobility type.

9. The WTRU of claim 1, wherein the one or more first conditions comprises a volume of the collected data, and wherein the processor is configured to discard the collected data when the volume of collected data exceeds a volume threshold.

10. The WTRU of claim 1, wherein the processor is configured to discard the collected data by being configured to:
send a message to a network, the message comprising a request to discard the collected data; and
receive a message from the network, the message comprising an indication to discard the collected data.

11. A method performed by a wireless transmit/receive unit (WTRU), the method comprising:
receiving configuration information, wherein the configuration information comprises one or more first conditions associated with collected data;
determining to perform handover (HO) from a first cell to a second cell;
in response to determining to perform HO from the first cell to the second cell, determining whether the one or more first conditions associated with the collected data are satisfied;
performing HO to the second cell; and
in response to performing HO to the second cell and based on determining whether the one or more first conditions associated with collected data are satisfied, performing one or more of the following:
maintaining the collected data;
discarding the collected data; or
maintaining the collected data for a predetermined time.

12. The method of claim 11, wherein the one or more first conditions comprise at least one of a condition for maintaining the collected data, a condition for discarding the collected data, or a condition for maintaining the collected data for the predetermined time, and wherein the method comprises performing one or more of the following:
maintaining the collected data based on a determination that the condition for maintaining collected data is satisfied;
discarding the collected data based on a determination that the condition for discarding the collected data is satisfied; or
maintaining the collected data for the predetermined time based on a determination that the condition for maintaining the collected data for the predetermined time is satisfied.

13. The method of claim 11, comprising sending a HO complete message to a network, the HO complete message comprising an indication of one or more of the collected data being maintained, the collected data being discarded, or the collected data being maintained for the predetermined time.

14. The method of claim 11, comprising performing one or more of the following:
receiving a HO command from a network and determine to perform the HO to the second cell based on the HO command from the network; or
determining to perform the HO to the second cell based on one or more conditional handover (CHO) conditions being satisfied.

15. The method of claim 11, wherein the one or more first conditions comprises an indication of whether the first cell and the second cell are in a same data relevancy domain, and wherein the method comprises performing one or more of the following:
determining to maintain the collected data, discarding the collected data, or maintaining the collected data for a predetermined time based on a determination of whether the first cell and second cell are in the same data relevancy domain.

16. The method of claim 15, comprising performing one or more of the following:
maintaining the collected data based on a determination that the first cell and the second cell are in the same data relevancy domain;
discarding the collected data based on a determination that the first cell and the second cell are not in the same data relevancy domain; or
maintaining the collected data for the predetermined time based on a determination that the first cell and the second cell are not in the same data relevancy domain.

17. The method of claim 15, comprising maintaining the collected data for a predetermined time and discarding the collected data based on a determination that the predetermined time has elapsed after performing the HO to the second cell and based on a determination that the WTRU has not performed a second HO to one or more of the first cell or to a third cell, the third cell being in a same data relevancy domain as the first cell.

18. The method of claim 11, wherein the one or more first conditions comprises a mobility type, and wherein the method comprises determining whether the one or more first conditions associated with the collected data are satisfied based on the mobility type.

19. The method of claim 11, wherein the one or more first conditions comprises a volume of the collected data, and wherein the method comprises discarding the collected data when the volume of collected data exceeds a volume threshold.

20. The method of claim 11, wherein discarding the collected data comprises:
sending a message to a network, the message comprising a request to discard the collected data; and
receiving a message from the network, the message comprising an indication to discard the collected data.
